(19) United States
(12) Patent Application Publication
(10) Pub. No.: US 2026/0041532 A1
(43) Pub. Date: Feb. 12, 2026

(54) ORAL CLEANING APPARATUS, DEVICE AND SYSTEM

(71) Applicant: Shenzhen Soocas Technology Co., Ltd., Shenzhen (CN)

(72) Inventors: Wenxu GAN, Shenzhen (CN); Yuanping ZHANG, Shenzhen (CN); Zhoujian LI, Shenzhen (CN)

(73) Assignee: Shenzhen Soocas Technology Co., Ltd., Shenzhen (CN)

(21) Appl. No.: 18/985,085

(22) Filed: Dec. 18, 2024

Related U.S. Application Data
(63) Continuation of application No. PCT/CN2024/128307, filed on Oct. 29, 2024.

(30) Foreign Application Priority Data
Aug. 9, 2024 (CN) 202421934295.5

(51) Int. Cl. A61C 17/16

(52) U.S. Cl. CPC A61C 17/16

(57) ABSTRACT

The present disclosure discloses an oral cleaning apparatus, device and system, where the oral cleaning apparatus includes a shell body, a bracket assembly, a power assembly, and a charging receiver assembly. The bracket assembly, the power assembly, and the charging receiver assembly are all arranged in an inner cavity of the shell body, and both the power assembly and the charging receiver assembly are assembled on the bracket assembly.

### CROSS-REFERENCE TO RELATED APPLICATION

This application is a continuation of International Application No. PCT/CN2024/128307, filed on Oct. 29, 2024, which claims priority to Chinese Patent Application No. 202421934295.5, titled “ORAL CLEANING APPARATUS, DEVICE AND SYSTEM” and filed to the China National Intellectual Property Administration on Aug. 9, 2024, the entire contents of which are incorporated herein by reference.

### TECHNICAL FIELD

Embodiments of the present disclosure relate to the field of oral cleaning technology, and more particularly, to an oral cleaning apparatus, device and system.

### BACKGROUND

As people pay more attention to oral care, electric toothbrushes and oral irrigators have gradually become common household oral care tools. By means of high-frequency vibration of toothbrush heads driven by motors, the electric toothbrushes can break toothpastes into fine foam in an instant and clean slits between teeth thoroughly. Water pumps can pump out high-speed water columns with a certain pressure, so the oral irrigators can clean the teeth and the slits between teeth by means of impingement force of the high-speed water columns.

As portable mobile devices, oral cleaners may be internally equipped with rechargeable batteries to provide power to electrical components (such as pumps or motors) inside the oral cleaners. The oral cleaners are internally provided with charging converters, and the oral cleaners are externally equipped with charging docks, such that external power supplies can charge the rechargeable batteries through the charging docks and the charging converters.

However, the related oral cleaners have a problem of lower assembly efficiency.

### SUMMARY

One aspect of the embodiments of the present disclosure provides an oral cleaning apparatus, which includes a shell body, a bracket assembly, a power assembly, and a charging receiver assembly. The bracket assembly, the power assembly, and the charging receiver assembly are all arranged in an inner cavity of the shell body, and both the power assembly and the charging receiver assembly are assembled on the bracket assembly.

Another aspect of the embodiments of the present disclosure also provides an oral cleaning apparatus, which includes a cleaning accessory and the oral cleaning apparatus as described above, where the cleaning accessory is arranged at one end of the oral cleaning apparatus.

Yet another aspect of the embodiments of the present disclosure also provides an oral cleaning system, which includes a charging transmitter assembly and the oral cleaning apparatus as described above, where the charging transmitter assembly matches up with the charging receiver assembly of the oral cleaning apparatus to transfer electric energy.

### BRIEF DESCRIPTION OF THE DRAWINGS

To describe the technical solutions in the embodiments of the present disclosure more clearly, the accompanying drawings required for describing the embodiments will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a schematic diagram of an oral cleaning device according to an embodiment of the present disclosure;

FIG. 2 is a longitudinal profile view of the oral cleaner shown in FIG. 1;

FIG. 3 is a partial view of another longitudinal profile of the oral cleaner shown in FIG. 1;

FIG. 4 is an internal layout diagram of an oral cleaning apparatus according to an embodiment of the present disclosure;

FIG. 5 is another internal layout diagram of the oral cleaning apparatus according to an embodiment of the present disclosure;

FIG. 6 is a section view of a separator shown in FIG. 3;

FIG. 7 is an exploded view of the oral cleaner according to an embodiment of the present disclosure;

FIG. 8 is an exploded view of a motor, a connector, a mounting member and a control board shown in FIG. 7;

FIG. 9 is an assembly stereogram of the mounting member, the connector and a pump mechanism shown in FIG. 8;

FIG. 10 is an exploded view of the connector, the mounting member and the motor of the oral cleaner according to an embodiment of the present disclosure;

FIG. 11 is an exploded view of the pump mechanism, the mounting member and the connector shown in FIG. 10;

FIG. 12 is a partial schematic diagram of FIG. 2; and

FIG. 13 is an exploded view of a connector according to an embodiment of the present disclosure;

FIG. 14 is an assembly diagram of a charging receiver assembly according to an embodiment of the present disclosure;

FIG. 15 is an exploded view of the charging receiver assembly shown in FIG. 14; and

FIG. 16 is an exploded view of a charging transmitter assembly shown in FIG. 1.

### REFERENCE NUMERALS IN THE ACCOMPANYING DRAWINGS

oral cleaning apparatus 1000;

casing 100; power cavity 110; liquid storage cavity 120; top end 160; bottom end 170;

motor 200; output shaft 210; first flow channel 211; motor body 220;

pump mechanism 300; liquid inlet end 310; first valve part 311; first end cover part 312; liquid outlet end 320; second valve part 321; second end cover part 322; power end 330; pump housing 331; piston 332; driving member 333;

connector 400; second flow channel 410; first flow segment 411; second flow segment 412; first arc segment 4121; second arc segment 4122; third flow channel 420; first connecting part 430; reversing chamber 431; first intrados 432; second connecting part 440; second intrados 441; cover plate segment 442; convex segment 443; baffle segment 444; mounting groove 450;

mounting member 500; first mounting part 510; second mounting part 520; through hole 530; positioning slot 540;

separator 600; accommodating chamber 610; accommodating hole 620; first part 630; second part 640; third part 650; fourth flow channel 651; fourth part 660; fifth part 670; intercommunicating pore 680;

energy source 710; control board 720; charging receiver assembly 730; charging receiver 731; first magnet 732; first sealing element 810; second sealing element 820; fourth sealing element 840;

second vibration damper 912; third vibration damper 913; fourth vibration damper 914;

first fastener 921; second fastener 922; third fastener 923; fourth fastener 924;

cleaning accessory 2000; brush body 2100; cavity 2200; outlet 2300; and

charging transmitter assembly 3000; base shell 3100; circuit board 3200; charging transmitter 3300; second magnet 3400.

### DETAILED DESCRIPTION

Objectives of embodiments of the present disclosure are to provide an oral cleaning apparatus, device and system, which can solve the problem of lower assembly efficiency of an oral cleaner.

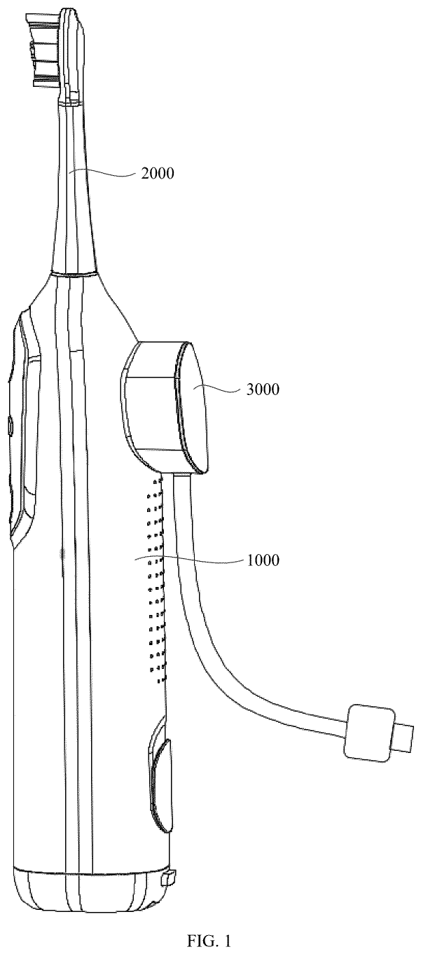

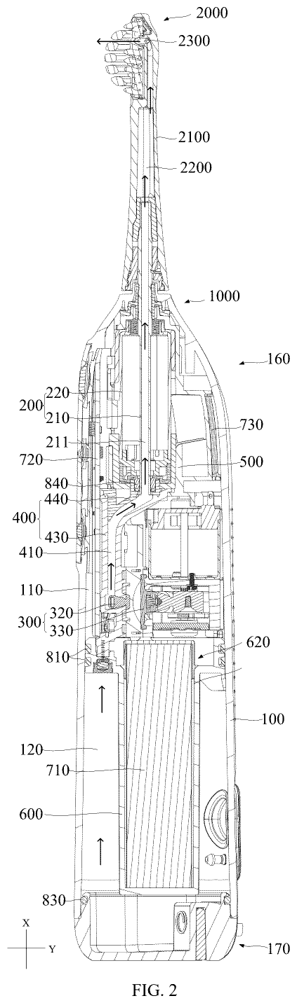

FIG. 1 is a schematic diagram of an oral cleaning device according to an embodiment of the present disclosure, and FIG. 2 is a longitudinal profile view of the oral cleaning device shown in FIG. 1. With reference to FIG. 1 and FIG. 2, the oral cleaning device provided in the embodiments of the present disclosure may include an oral cleaning apparatus 1000 and a cleaning accessory 2000, where the cleaning accessory 2000 may be a device capable of cleaning an oral cavity, such as a toothbrush head, a washing head, or an integrated rinsing head.

A specific structure of the oral cleaning apparatus 1000 provided in the embodiments of the present disclosure is described below first taking an example where the cleaning attachment 2000 is the integrated rinsing head. Specifically, the cleaning accessory 2000 may include a brush body 2100, and the brush body 2100 may have a cavity 2200 and an outlet 2300 communicated with the cavity 2200.

With continued reference to FIG. 2, the oral cleaning apparatus 1000 may include a casing 100, a power assembly, a charging receiver assembly, and a bracket assembly. To make it easier for users to grip, the casing 100 may be shaped like a slender cylinder. A cross section of the casing 100 may be circular or non-circular (such as D-shaped, oval, or polygonal). The casing 100 may extend along a first direction X (an up-down direction in FIG. 2), and the casing 100 may have, along the first direction X, a top end 160 and a bottom end 170 arranged opposite to each other. Interior of the casing 100 may be hollow to form an inner cavity of the casing 100.

The power assembly may be arranged in the inner cavity of the casing 100, and the power assembly may include a motor 200 and a pump mechanism 300. To maintain the slender shape of the casing 100, the motor 200 and the pump mechanism 300 may be arranged in sequence along the first direction X. The motor 200 may be closer to the top end 160 (as shown in FIG. 2, the motor 200 is positioned above the pump mechanism 300) of the casing 100 than the pump mechanism 300, such that an output shaft 210 of the motor 200 can pass through the top end 160 of the casing 100 and can be connected to the cleaning accessory 2000 (an accessory having brush bristles, such as the toothbrush head or the integrated rinsing head), to drive the cleaning accessory 2000 to move. The motor 200 may be a rotating motor 200 capable of rotating the cleaning accessory 2000, or the motor 200 may be a vibration motor 200 (such as an acoustic motor 200) enabling the cleaning accessory 2000 to swing at a higher frequency. The motor 200 may include a motor body 220 and the output shaft 210. An axis of the output shaft 210 and a central axis of the casing 100 may coincide with each other or may be arranged at parallel intervals. The output shaft 210 may pass through the motor body 220 along its axial direction. The top end 160 of the output shaft 210 along its axial direction may pass through the top end 160 of the motor body 220 and may be connected to the cleaning accessory 2000, to drive the cleaning accessory 2000 to move.

The output shaft 210 may have a first flow channel 211 that runs through the output shaft 210 along its axial direction. The oral cleaning apparatus provided in the embodiments of the present disclosure may also include a built-in water tank, which may be formed in the inner cavity of the casing 100 and may have a liquid storage cavity 120 for storing a liquid.

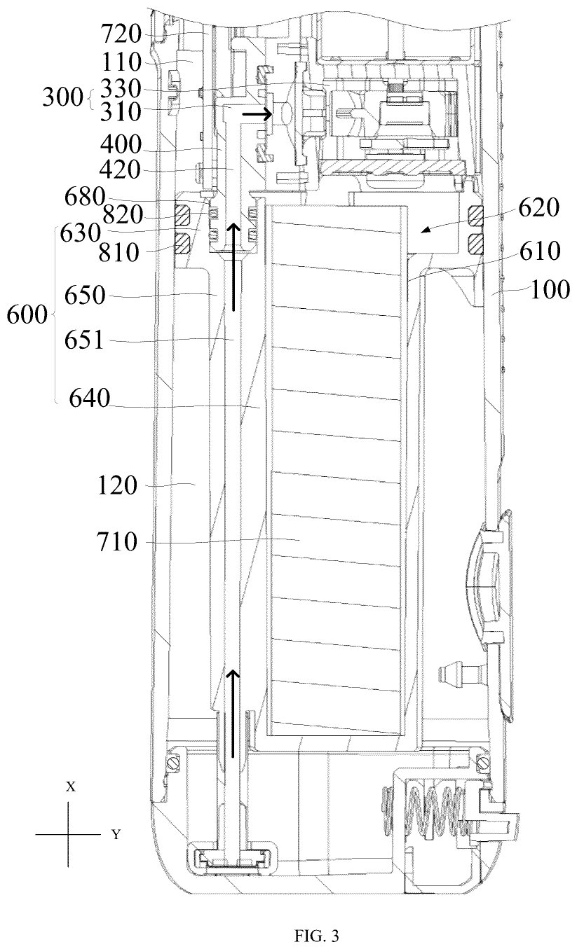

FIG. 3 is a partial view of another longitudinal profile of the oral cleaning device shown in FIG. 2. Referring to FIG. 2 and FIG. 3, the bracket assembly may include a connector 400, which may have a second flow channel 410 and a third flow channel 420. It is to be noted that the third flow channel 420 and the second flow channel 410 are not in the same longitudinal profile, so the second flow channel 410 can be seen from the profile shown in FIG. 2, and the third flow channel 420 can be seen from FIG. 3.

The third flow channel 420 can communicate the liquid storage cavity 120 with a liquid inlet end 310 of the pump mechanism 300, and the second flow channel 410 can communicate a liquid outlet end 320 of the pump mechanism 300 with the first flow channel 211. In this way, both the second flow channel 410 and the third flow channel 420 are integrated on the connector 400, which not only reduces number of parts required for assembly and improves assembly efficiency, but also improves overall structural strength of the second flow channel 410 and the third flow channel 420 to resist the impingement force of the water flow. Further, stability of connection between the liquid storage cavity 120 and the second flow channel 410, between the second flow channel 410 and the pump mechanism 300, between the pump mechanism 300 and the third flow channel 420, and between the third flow channel 420 and the first flow channel 211 of the output shaft 210 is improved to reduce the risk of liquid leakage at the connection.

The first flow channel 211 of the output shaft 210 may be communicated with the outlet 2300 through the cavity 2200 of the cleaning accessory 2000. Arrows in FIG. 2 and FIG. 3 indicate flow directions of the liquid. Referring to the arrows in FIG. 2 and FIG. 3, when the oral cleaning device realizes its rinsing function, the pump mechanism 300 can guide the liquid in the liquid storage cavity 120 to flow into the pump chamber of the pump mechanism 300 through the third flow channel 420 and the liquid inlet end 310 of the pump mechanism 300, then the liquid flows into the first flow channel 211 through the liquid outlet end 320 of the pump mechanism 300 and the second flow channel 410, and then the liquid flows out of the outlet 2300 through the cavity 2200 of the cleaning accessory 2000.

Referring to FIG. 2, the power assembly (the motor 200 and the pump mechanism 300) and the liquid storage cavity 120 may be arranged in sequence along the first direction X (as shown in FIG. 1, the power assembly is positioned above the liquid storage cavity 120), to shorten the longitudinal length of the liquid storage cavity 120 to make it easier for the users to clean the water tank. Furthermore, the transverse width of the casing 100 can also be reduced, to make it easier for the users to grip. The pump mechanism 300 is closer to the liquid storage cavity 120 than the motor 200, to make it easier for the pump mechanism 300 to pump the liquid from the liquid storage cavity 120.

To increase a vertical height of the liquid storage cavity 120 to increase the volume of the liquid storage cavity 120, referring to FIG. 2 and FIG. 3, alternatively, the liquid outlet end 320 of the pump mechanism 300 can pump out the liquid along a second direction Y, and both the liquid inlet end 310 and the liquid outlet end 320 of the pump mechanism 300 may be arranged on a side of the pump mechanism 300 along the second direction Y, where the second direction Y intersects the first direction X. In this way, the length of the pump mechanism 300 in the first direction X is shortened, and the length of the liquid storage cavity 120 in the first direction X is increased, such that the volume of the liquid storage cavity 120 is increased. Further, the second direction Y is perpendicular to the first direction X. As shown in FIG. 2 and FIG. 3, the first direction X is the up-down direction, the second direction Y is a left-right direction, and both the liquid inlet end 310 and the liquid outlet end 320 of the pump mechanism 300 are arranged on a left side of the pump mechanism 300.

To efficiently use side space of the pump mechanism 300, further, the connector 400 may be connected to a side (the left side as shown in FIG. 2 and FIG. 3) of the pump mechanism 300 along the second direction Y, such that the third flow channel 420 and at least a portion of the second flow channel 410 are positioned on the side (the left side as shown in FIG. 2 and FIG. 3) of the pump mechanism 300 along the second direction Y. A connection between the connector 400 and the liquid storage cavity 120 may be positioned on the side (the left side as shown in FIG. 3) of the pump mechanism 300 along the second direction Y, to shorten the distance between the liquid inlet end 310 of the pump mechanism 300 and the liquid storage cavity 120, such that it is easier for the pump mechanism 300 to pump the liquid in the liquid storage cavity 120.

Further, in the first direction X, both the liquid inlet end 310 and the liquid outlet end 320 of the pump mechanism 300 may be closer to the liquid storage cavity 120. That is, both the liquid inlet end 310 and the liquid outlet end 320 of the pump mechanism 300 are arranged at an end of the pump mechanism 300 closer to the liquid storage cavity 120 along the first direction X. In this way, the distance between the liquid inlet end 310 of the pump mechanism 300 and the bottom of the liquid storage cavity 120 is shortened, to make it easier for the pump mechanism 300 to pump the liquid in the liquid storage cavity 120. Furthermore, the distance between the liquid outlet end 320 of the pump mechanism 300 and the first flow channel 211 is increased, to reduce the impingement force of the liquid at the liquid outlet end 320 of the pump mechanism 300 against the output shaft 210 of the motor 200, thereby improving the connection stability.

The oral cleaning apparatus 1000 provided in the embodiments of the present disclosure may also include an energy source 710, which may be a device such as a rechargeable battery or accumulator battery that can supply electric energy to the motor 200, the pump mechanism 300, and electrical devices on a control board 720. To maintain the slim shape of the oral cleaning apparatus 1000, the energy source 710 may be positioned on a side (a lower side as shown in FIG. 2 and FIG. 3) of the pump mechanism 300 away from the motor 200 along the first direction X. At least a portion of the energy source 710 is arranged side-by-side with at least a portion of the liquid storage cavity 120. That is, a plane projection of at least a portion of the energy source 710 along the first direction X at least partially overlaps with a plane projection of the liquid storage cavity 120 along the first direction X. That is, the energy source 710 and the liquid storage cavity 120 jointly occupy the bottom end 170 of the casing 100.

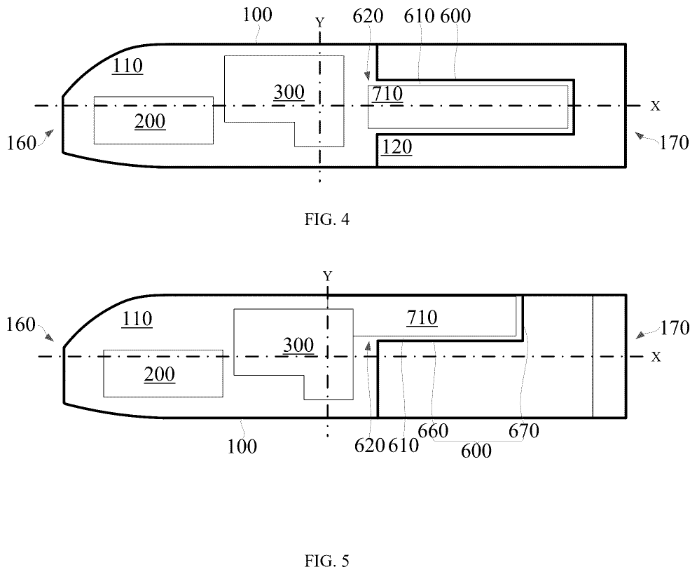

FIG. 4 is another internal layout diagram of the oral cleaning apparatus according to an embodiment of the present disclosure. Referring to FIGS. 2 to 4, as an example, the liquid storage cavity 120 may wrap on a side of the energy source 710 in a first axial direction. For example, in FIG. 4, the liquid storage cavity 120 may wrap on an outer lateral surface and a bottom surface of the energy source 710. That is, in the first axial direction, the energy source 710 has a top surface and the bottom surface arranged opposite to each other, and the casing 100 may have an inner top surface and an inner bottom surface arranged opposite to each other. A spacing is provided between the bottom surface of the energy source 710 and the inner bottom surface of the casing 100, and at least a portion of the liquid storage cavity is positioned between the bottom surface of the energy source 710 and the inner bottom surface of the casing 100. That is, the liquid storage cavity 120 may be concave in shape, and the energy source 710 may be positioned in a hollow of the concave liquid storage cavity 120. For another example, the liquid storage cavity 120 may only wrap on the outer lateral surface of the energy source 710. That is, the bottom surface of the energy source 710 is propped on the inner bottom surface of the casing 100. In other words, at least a portion of the end of the energy source 710 extending along the first direction X is wrapped by the liquid storage cavity 120.

FIG. 5 is another internal layout diagram of the oral cleaning apparatus according to an embodiment of the present disclosure. Referring to FIG. 5, as another example, a space for placing the energy source 710 is formed between the liquid storage cavity 120 and an inner shell wall of the casing 100. That is, the space for placing the energy source 710 is formed between the separator 600 and the inner shell wall of the casing 100. For example, in FIG. 5, the liquid storage cavity 120 may wrap on the bottom surface of the energy source 710 and the outer lateral surface of at least a portion of the energy source 710. That is, a spacing is provided between the bottom surface of the energy source 710 and the inner bottom surface of the casing 100, and at least a portion of the liquid storage cavity is positioned between the bottom surface of the energy source 710 and the inner bottom surface of the casing 100. That is, the liquid storage cavity 120 may be L-shaped, and the energy source 710 may be positioned at a gap of the L-shaped liquid storage cavity 120. For another example, the liquid storage cavity 120 may only wrap on the outer lateral surface of the energy source 710. That is, the bottom surface of the energy source 710 is propped on the inner bottom surface of the casing 100.

The liquid storage cavity 120 may be formed by a shell body 130 independent of the casing 100, and the liquid storage cavity 120 may be detachably connected to the casing 100, such that the user can remove the liquid storage cavity 120 from the casing 100 to clean it. Alternatively, the liquid storage cavity 120 may be formed by the inner shell wall of the casing 100 and the separator 600. Specifically, referring to FIG. 4 and FIG. 5, the oral cleaning apparatus 1000 provided in the embodiments of the present disclosure may also include the separator 600, which may be arranged in the inner cavity of the casing 100 and can separate the inner cavity of the casing 100 into a power cavity 110 and the liquid storage cavity 120. The motor 200, the pump mechanism 300 and the energy source 710 may be arranged in the power cavity 110.

In FIG. 4 and FIG. 5, the separator 600 and the inner shell wall of the casing 100 positioned on a side (the left side as shown in FIG. 4 and FIG. 5) of the separator 600 along the first direction X may enclose to form the power cavity 110, and the separator 600 and the inner shell wall of the casing 100 positioned on other side (the right side as shown in FIG. 4 and FIG. 5) of the separator 600 along the first direction X may enclose to form the liquid storage cavity 120.

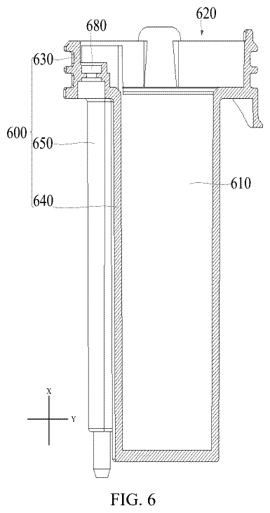

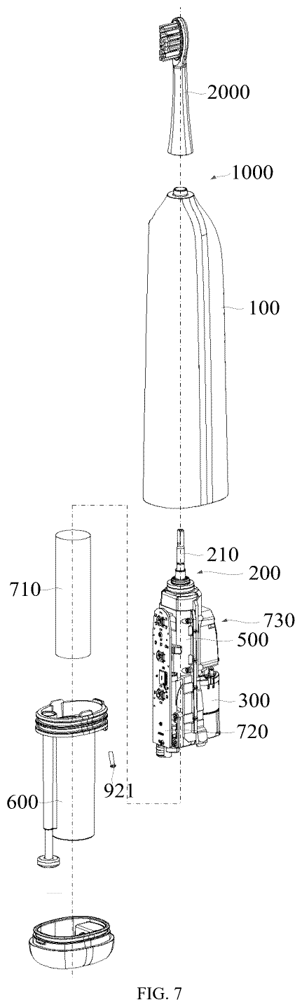

As an example, referring to FIG. 3 and FIG. 6, the separator 600 is detachably connected to the casing 100, so the user can remove the separator 600 from the casing 100 to clean it. A first sealing element 810 may be filled between the separator 600 and the casing 100 in consideration of tightness. For example, an outer sidewall of the separator 600 may be provided with a first sealing groove, and a first sealing cavity may be formed between the first sealing groove and the inner shell wall of the casing 100, where the first sealing element 810 may be a first sealing ring, which may be sealed in the first sealing cavity to prevent liquid leakage. In addition, the separator 600 may be detachably connected to the casing 100 by means of clamping connection; and/or, the separator 600 is securely connected to the connector 400 (or a mounting member 500 hereinafter mentioned) by means of fasteners such as bolts. Further, connection of the fasteners may be waterproofed. For example, referring to FIG. 7, the separator 600 may have a blind hole, the connector 400 or the mounting member 500 may be provided with a threaded hole, and a first fastener 921 may pass through the blind hole of the separator 600 and is connected to the threaded hole of the connector 400 or mounting member 500 by means of thread.

As another example, the separator 600 and the casing 100 may be an integrated element formed by means of an integrated forming process to facilitate assembly and improve connection strength.

FIG. 6 is a section view of the separator 600 shown in FIG. 3. Referring to FIG. 3 and FIG. 6, to communicate the liquid inlet end 310 of the pump mechanism 300 arranged in the power cavity 110 with the liquid storage cavity 120, the separator 600 may have an intercommunicating pore 680 communicating the power cavity 110 with the liquid storage cavity 120, and the third flow channel 420 of the connector 400 may be communicated with the liquid storage cavity 120 through the intercommunicating pore 680. To shorten the distance between the liquid inlet end 310 of the pump mechanism 300 and the liquid storage cavity 120, alternatively, the intercommunicating pore 680 may be arranged on a side (the left side as shown in FIG. 3) of the pump mechanism 300 along the second direction Y.

To avoid liquid leakage, alternatively, the connector 400 may be hermetically connected to the intercommunicating pore 680 by means of a second sealing element 820. Specifically, a second sealing groove may be provided on the outer sidewall of the connector 400, and a second sealing cavity may be formed between the second sealing groove and an inner hole wall of the intercommunicating pore 680, where the second sealing element 820 may be a second sealing ring, which may be sealed in the second sealing cavity.

The separator 600 may form an accommodating hole 620 and an accommodating chamber 610 for accommodating the energy source 710, where the accommodating hole 620 may be arranged on a side (an upper side as shown in FIG. 3 and FIG. 6) of the accommodating chamber 610 facing toward the pump mechanism 300 along the first direction X. As shown in FIGS. 2 to 4 and FIG. 6, the separator 600 can separately form the accommodating hole 620 and the accommodating chamber 610. Alternatively, as shown in FIG. 5, the separator 600 may form, together with the inner shell wall of the casing 100, the accommodating hole 620 and the accommodating chamber 610.

In one possible structure of the separator 600, referring to FIGS. 2 to 4 and FIG. 6, when the liquid storage cavity 120 is wrapped on a side of the energy source 710 along the first direction X, the separator 600 may include a first part 630 and a second part 640 sequentially communicated along the first direction X, and the first part 630 is closer to the pump mechanism 300 than the second part 640. An inner sidewall of the first part 630 may form the accommodating hole 620 and a portion of the accommodating chamber 610, and an inner sidewall of the second part 640 may form another portion of the accommodating chamber 610. An outer sidewall of the first part 630 and the inner shell wall of the casing 100 may match in shape, and the outer sidewall of the first part 630 is propped on the inner shell wall of the casing 100, and the first part 630 may form the intercommunicating pore 680. At least a portion of the liquid storage cavity 120 may be formed between an outer sidewall of the second part 640 and the inner shell wall of the casing 100.

For example, the liquid storage cavity 120 may be internally provided with a fourth flow channel 651 communicating the bottom of the liquid storage cavity 120 with the intercommunicating pore 680. The fourth flow channel 651 may be formed by a separate tube body. Alternatively, the fourth flow channel 651 may be formed by the separator 600 to facilitate assembly and improve strength of connection between the fourth flow channel 651 and the intercommunicating pore 680. Specifically, referring to FIG. 3, the separator 600 may also include a third part 650, which is integrally connected to the first part 630. The third part 650 may have a fourth flow channel 651 for liquid flow, and the fourth flow channel 651 may communicate the intercommunicating pore 680 with a side of the liquid storage cavity 120 away from the pump mechanism 300. Further, the fourth flow channel 651 may extend along the first direction X to reduce the length of the waterway between the liquid inlet end 310 of the pump mechanism 300 and the side of the liquid storage cavity 120 away from the pump mechanism 300.

In another possible structure of the separator 600, referring to FIG. 5, when the space for placing the energy source 710 is formed between the liquid storage cavity 120 and the inner shell wall of the casing 100, the separator 600 may include a fourth part 660, which may extend along the first direction X. At least a portion of the liquid storage cavity 120 may be formed between the fourth part 660 and a portion of the inner shell wall of the casing 100, and at least a portion of the accommodating chamber 610 may be formed between the fourth part 660 and another portion of the inner shell wall of the casing 100.

Further, the separator 600 may also include a fifth part 670, where the fifth part 670 may be connected between the fourth part 660 and the inner shell wall of the casing 100, and the fifth part 670 may provide support to the energy source 710 in the first direction X.

FIG. 7 is an exploded view of the oral cleaning device according to an embodiment of the present disclosure. With reference to FIG. 7, the oral cleaning device provided in the embodiment of the present disclosure may also include a mounting member 500. To facilitate assembly, the mounting member 500 is fixed to the inner shell wall of the casing 100, and both the motor 200 and the pump mechanism 300 may be mounted in the mounting member 500. Thus, during the assembly, the motor 200 and the pump mechanism 300 may be first assembled on the mounting member 500, and then they are mounted as one assembly into the casing 100.

It is to be noted that both the motor 200 and the pump mechanism 300 may vibrate during operation, which leads to poor reliability of connection between pipelines communicating the liquid outlet end 320 of the pump mechanism 300 and the first flow channel 211 of the output shaft 210, making them easy to fall off. In view of the above problems, the inventor of the present disclosure thinks of an idea of disassembling the pump mechanism 300 into a power end 330, the liquid inlet end 310 and the liquid outlet end 320, and integrating the liquid outlet end 320 onto the connector 400 and the mounting member 500 to reduce sympathetic vibration. In this way, reliability of the connection between the second flow channel 410 of the connector 400 and the liquid outlet end 320 of the pump mechanism 300 is improved.

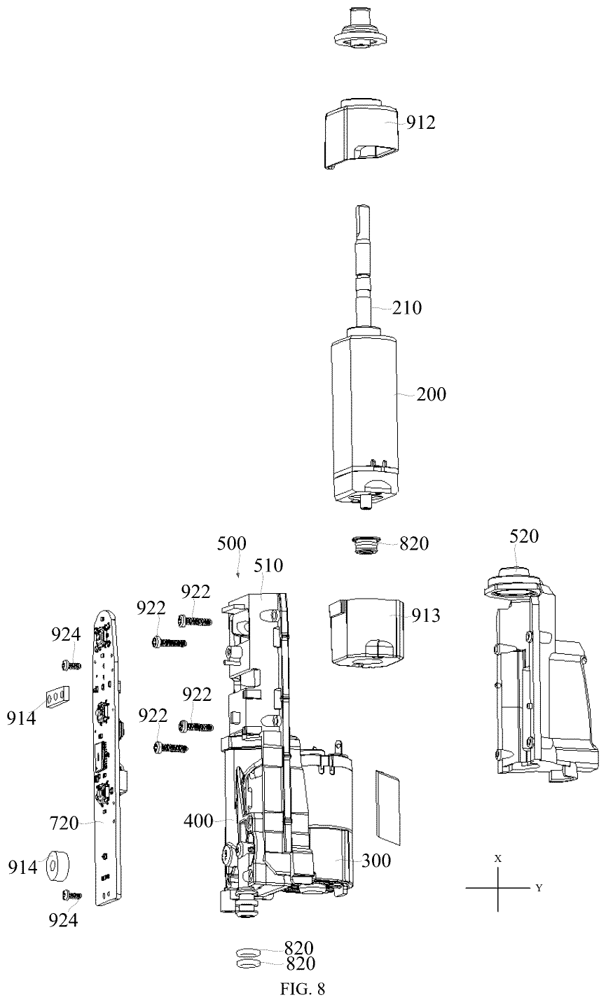

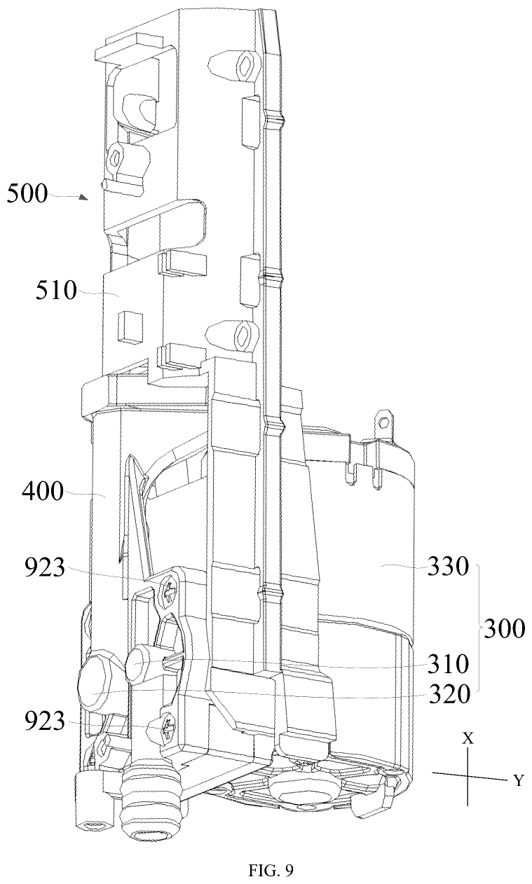

Specifically, referring to FIGS. 8 to 11, a second valve part 321 of the liquid outlet end 320 may be integrated onto the mounting member 500, and a second end cover part 322 of the liquid outlet end 320 may be integrated onto the connector 400. The power end 330, at least a portion of the connector 400, and at least a portion of the mounting member 500 may be arranged sequentially along a liquid outlet direction (the second direction Y) of the liquid outlet end 320, and may be connected by means of a third fastener 923. Thus, the mounting member 500 is separated between the connector 400 and the power end 330 of the pump mechanism 300, such that most of vibrations of the pump body is transmitted to the mounting member 500. A vibration damper may be arranged between the mounting member 500 and the inner shell wall of the casing 100, and the vibration of the mounting member 500 may be eliminated through vibration damping connection, such that the vibration transmitted from the power end 330 of the pump mechanism 300 to the connector 400 is so little that adverse impact of the vibration of the power end 330 of the pump mechanism 300 on the connector 400 is reduced. Thus, the reliability of connection between the second flow channel 410 of the connector 400 and the liquid outlet end 320 of the pump mechanism 300 is improved. In addition, the liquid outlet end 320 is integrated onto the mounting member 500 and the connector 400, which is not only convenient for assembly, but also has shorter waterways and higher connection reliability.

Alternatively, the power end 330 may include a pump housing 331 and a piston 332, where one end of the pump housing 331 may have an opening. The mounting member 500 can seal the opening, and the mounting member 500 and the pump housing 331 may enclose to form the pump chamber of the pump mechanism 300 for reciprocating movement of the piston 332 along a liquid discharge direction of the liquid outlet end 320. The mounting member 500 may have a liquid outlet hole penetrating through the mounting member 500 and communicated with the pump chamber of the pump mechanism 300, the second valve part 321 of the liquid outlet end 320 is arranged in the liquid outlet hole, and the second valve part 321 of the liquid outlet end 320 can allow the liquid to be pumped out of the pump chamber through the liquid outlet hole and prevent the liquid from flowing into the pump chamber through the liquid outlet hole.

Specifically, the reciprocating movement of the piston 332 in the pump chamber may enable the liquid in the pump chamber to be pumped out of the liquid outlet hole. The valve at the liquid outlet end 320 has unidirectional continuity, to prevent the liquid from flowing back to the pump chamber through the liquid outlet hole. In this solution, the pump chamber and the liquid outlet hole are formed by means of the mounting member 500 to realize the objective of integrating the valve part of the liquid outlet end 320.

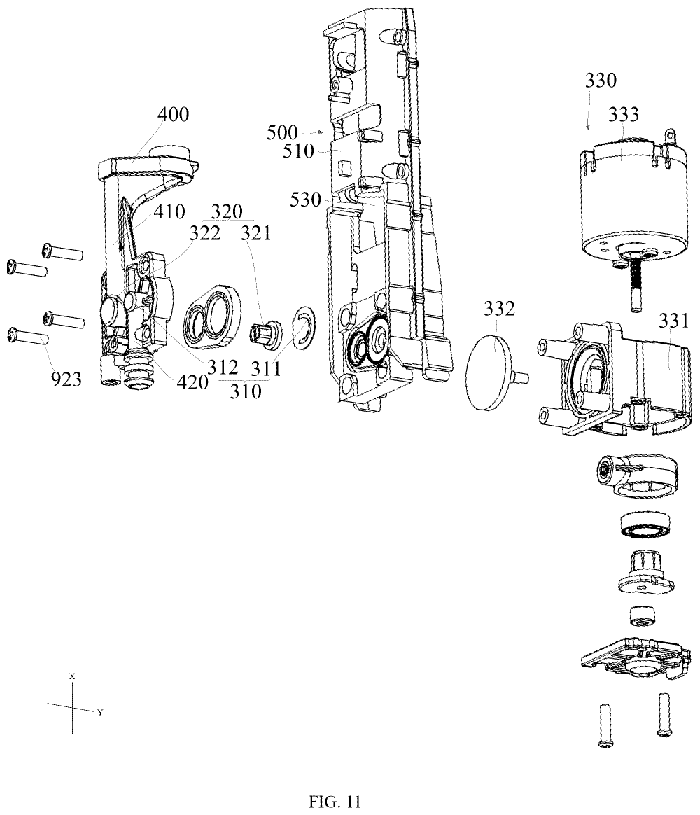

Alternatively, referring to FIG. 11, the power end 330 may also include a driving member 333, which may have a drive shaft rotating with respect to the pump housing 331. The drive shaft can drive an eccentric wheel to rotate with respect to the pump housing 331, and the eccentric wheel can touch the piston 332 to carry out a reciprocating movement.

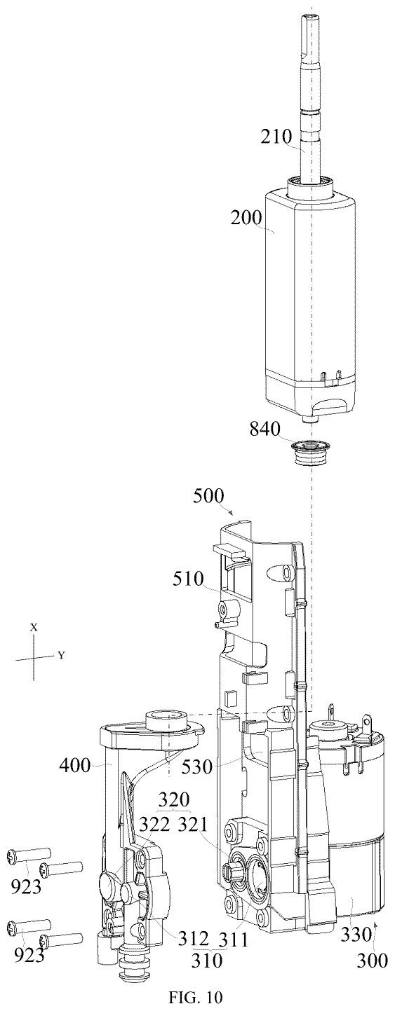

With reference to FIGS. 10 to 12, alternatively, at least a portion of the connector 400 and the second end cover part 322 of the liquid outlet end 320 may be fabricated into an integrated element by means of an integrated forming process. The second end cover part 322 of the liquid outlet end 320 may cover the liquid outlet hole, and the second end cover part 322 of the liquid outlet end 320 may form a liquid outlet flow channel communicating the liquid outlet hole with the second flow channel 410.

Specifically, a liquid outlet channel of the second end cover part 322 of the liquid outlet end 320 can guide a flow direction of the liquid flowing out of the liquid outlet hole. In this solution, the connector 400 and the second end cover part 322 of the liquid outlet end 320 are fabricated into the integrated element, such that the liquid outlet channel and the second flow channel 410 are integrated, which is conducive to improving the connection reliability, improving smoothness of liquid flow, and improving convenience of assembly.

Alternatively, the mounting member 500 may have a liquid outlet hole penetrating through the mounting member 500 and communicated with the pump chamber of the pump mechanism 300. The first valve part 311 of the liquid inlet end 310 may be arranged in the liquid inlet hole, and the first valve part 311 of the liquid inlet end 310 can allow the liquid to be pumped into the pump chamber through the liquid inlet hole and prevent the liquid from flowing out through the liquid inlet hole.

Specifically, the reciprocating movement of the piston 332 in the pump chamber may enable the liquid to be pumped into the pump chamber through the liquid inlet hole. The valve at the liquid inlet end 310 has unidirectional continuity, to prevent the liquid from flowing out through the liquid inlet hole. In this solution, the pump chamber and the liquid inlet hole are formed by means of the mounting member 500 to realize the objective of integrating the first valve part 311 of the liquid inlet end 310.

Alternatively, at least a portion of the connector 400 and the first end cover part 312 of the liquid inlet end 310 may be fabricated into an integrated element by means of an integrated forming process. The first end cover part 312 of the liquid inlet end 310 may cover the liquid inlet hole, and the first end cover part 312 of the liquid inlet end 310 may form a liquid inlet flow channel communicated with the liquid inlet hole, where the liquid inlet flow channel may be communicated with the third flow channel 420 of the connector 400. Thus, the liquid inlet channel of the first end cover part 312 of the liquid inlet end 310 can guide the flow direction of the liquid flowing into the liquid inlet hole. In this solution, the connector 400 and the first end cover part 312 of the liquid inlet end 310 are fabricated into an integrated element, such that the liquid inlet channel and the third flow channel 420 are integrated, which is conducive to improving the connection reliability, improving the smoothness of liquid flow, and improving the convenience of assembly.

Referring to FIGS. 8 to 11, alternatively, the mounting member 500 may include a first mounting part 510. The first mounting part 510 may have a first side and a second side arranged opposite to each other along the liquid discharge direction of the liquid outlet end 320. The motor 200 and the power end 330 of the pump mechanism 300 may be arranged on the first side of the first mounting part 510 at intervals along the axial direction of the output shaft 210. A portion of the connector 400, into which the second end cover part 322 of the liquid outlet end 320 is integrated, may be arranged on the second side of the first mounting part 510. The mounting member 500 may have a through hole 530 for allowing the connector 400 to pass through and limiting the connector 400 to be on at least one side along the axial direction of the output shaft 210. Thus, the connector 400 may be restricted by the through hole 530 to provide upward support and limit for the connector 400, thereby avoiding the connector 400 from vibrating up and down. Alternatively, the control board 720 may be mounted on a side of the first mounting part 510 facing away from the motor 200 by means of the fourth fastener 924. A fourth vibration damper 914 may be provided between the control board 720 and the inner shell wall of the casing 100.

With reference to FIG. 7 and FIG. 8, alternatively, the mounting member 500 may also include a second mounting part 520. The second mounting part 520 may be in an involutory connection to the first side of the first mounting part 510, and the second mounting part 520 and the first mounting part 510 may enclose to form accommodating space for wrapping the outer lateral surface of the motor 200. In this way, the mounting member 500 is wrapped on the outer lateral surface of the motor 200, such that most of the vibrations of the motor 200 is transmitted to the mounting member 500, such that the vibration transmitted from the motor 200 to the connector 400 is so little that adverse impact of the vibration of the power end 330 of the motor 200 on the connector 400 is reduced. Thus, the reliability of connection between the second flow channel 410 of the connector 400 and the first flow channel 211 of the motor 200 is improved. Alternatively, referring to FIG. 8, the first mounting part 510 and the second mounting part 520 may be securely connected by means of a second fastener 922.

Alternatively, a vibration damper is sandwiched between the first mounting part 510 and the outer lateral surface of the motor 200; and/or a vibration damper is sandwiched between the second mounting part 520 and the outer lateral surface of the motor 200. In this way, vibration transmission between the motor 200 and the mounting member 500 may be reduced by means of the vibration damper. For example, in FIG. 8, a second damper 912 is sandwiched between a front end of the motor 200 and the mounting member 500, and a third damper 913 is sandwiched between a rear end of the motor 200 and the mounting member 500.

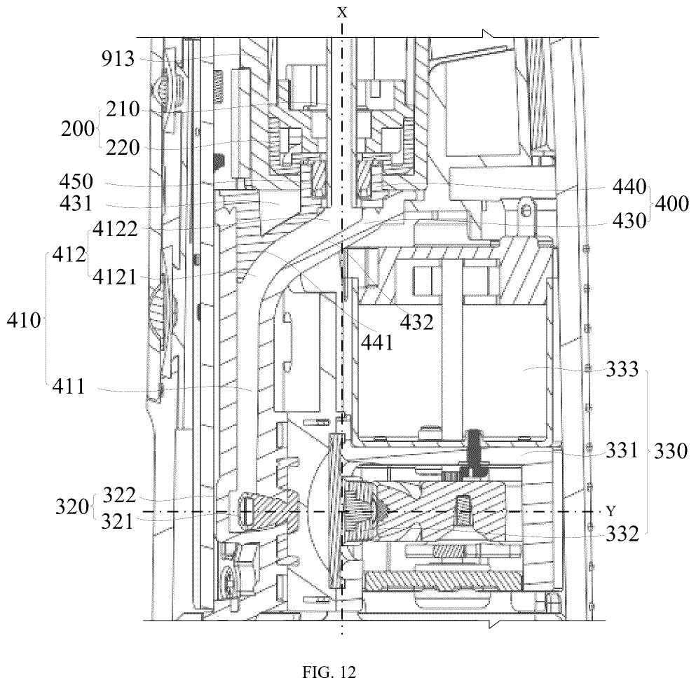

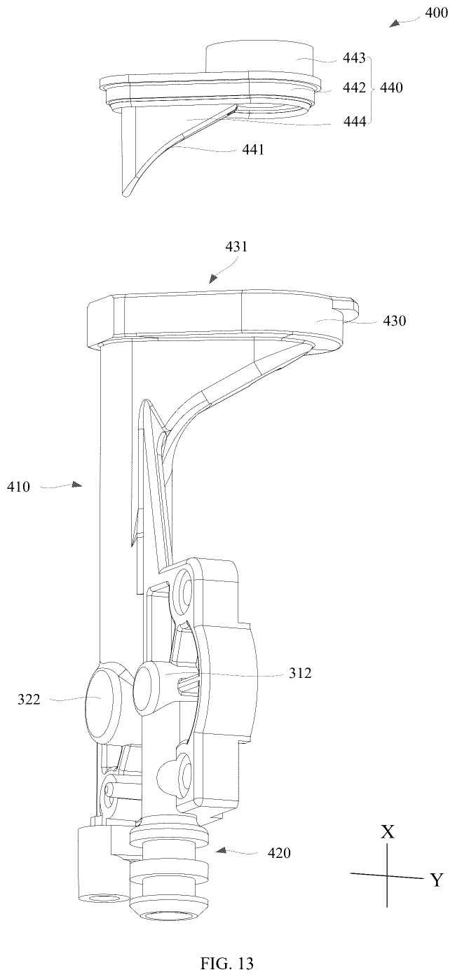

With reference to FIG. 12, alternatively, the connector 400 may have a mounting groove 450 for penetration by the output shaft 210 of the motor 200, and a fourth sealing element 840 may be filled between an inner groove wall of the mounting groove 450 and the output shaft 210 of the motor 200. Specifically, the first flow channel 211 of the output shaft 210 may be communicated, at the mounting groove 450, with the second flow channel 410 of the connector 400. Arrangement of the sealing element can prevent liquid leakage at the connection.

With continued reference to FIG. 12, alternatively, the motor 200 may include the motor body 220 and the output shaft 210. The output shaft 210 of the motor 200 may pass through the motor body 220, and two ends of the output shaft 210 along its axial direction may penetrate through the motor body 220. The bottom surface of the motor body 220 and the inner groove wall of the mounting groove 450 may enclose to form a confining space for confining the fourth sealing element 840. The confining space can confine two ends of the fourth sealing element 840 along the axial direction of the output shaft 210. Thus, the fourth sealing element 840 may be restricted by the bottom surface of the motor body 220 of the motor 200 and the groove bottom wall of the mounting groove 450, to prevent the fourth sealing element 840 from moving with vibration.

With reference to FIG. 12, the second flow channel 410 may include a first flow segment 411 and a second flow segment 412 communicated sequentially. The first flow segment 411 is communicated with the liquid outlet end 320 and may extend along the first direction X, and a spacing is provided between the first flow segment 411 and the first flow channel 211 along a second axial direction. The second flow segment 412 may communicate the first flow segment 411 with the first flow channel 211, and the second flow segment 412 may include the first arc segment 4121, where circular arc transition is achieved between the first arc segment 4121 and the first flow segment 411. Use of the circular arc transition can reduce resistance of an inner wall of the flow channel to the liquid, which is conducive to flow of the liquid.

Further, the first arc segment 4121 may be higher than the pump mechanism 300, and the first arc segment 4121 may have an arc center facing toward the pump mechanism 300, such that the liquid flows more gently toward the first flow channel 211 to further reduce the resistance of the inner wall of the flow channel to the liquid.

Alternatively, the second flow segment 412 also includes a second arc segment 4122, where circular arc transition is achieved between the second arc segment 4122 and the first flow channel 211. Use of the circular arc transition can reduce the resistance of the inner wall of the flow channel to the liquid, which is conducive to flow of the liquid.

Further, the second arc segment 4122 has an arc center toward the motor 200 such that the second arc segment 4122 smoothly borders with the first flow channel 211, which is conducive to flow of the liquid.

With reference to FIG. 12 and FIG. 13, alternatively, the connector 400 may include a first connecting part 430 and a second connecting part 440 connected to each other. The first connecting part 430 may have the first flow segment 411 and a reversing chamber 431 communicated with the first flow segment 411, where the reversing chamber 431 may have a first intrados 432, and the reversing chamber 431 may have an opening along the first direction X. At least a portion of the second connecting part 440 may be internally mounted in the reversing chamber 431 through the opening of the reversing chamber 431 and may have a second intrados 441. The first intrados 432 and the second intrados 441 may enclose to form the second flow segment 412.

Specifically, the second connecting part 440 may include a cover plate segment 442, a convex segment 443, and a baffle segment 444. The convex segment 443 and the baffle segment 444 may be connected to two sides of the cover plate segment 442 along the first direction X, respectively. The cover plate segment 442 may cover the reversing chamber 431, and the baffle segment 444 may be positioned in the reversing chamber 431 and may have the second intrados 441. The cover plate segment 442 may be provided with a via hole, the convex segment 443 may surround an outer side of the via hole, and an inner cavity of the convex segment 443 may be communicated with the via hole. The output shaft 210 may pass through the inner cavity of the convex segment 443 and the via hole, and the fourth sealing element 840 is arranged between the output shaft 210 and an inner cavity wall of the convex segment 443. Thus, the convex segment 443 and a portion of the cover plate segment 442 may form the mounting groove 450 mentioned above.

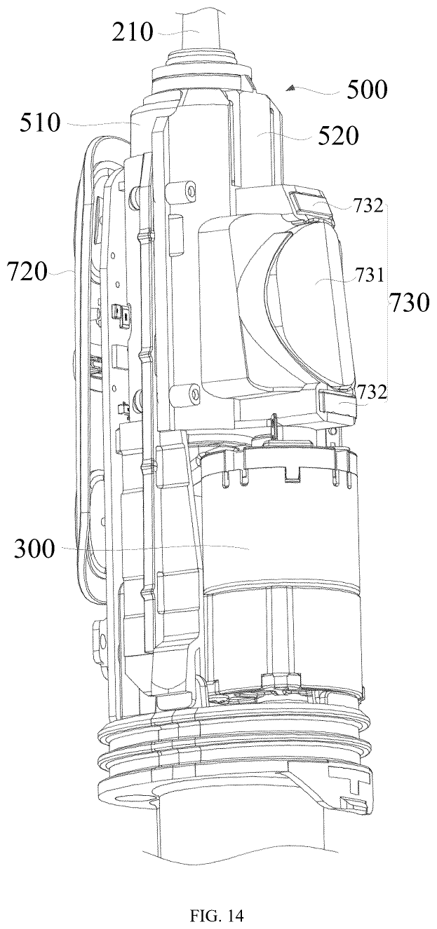

Referring to FIG. 8 and FIG. 14, both the power assembly (the motor 200 and the pump mechanism 300) and the charging receiver assembly 730 may be assembled on the mounting member 500, such that the mounting member 500, the power assembly, and the charging receiver assembly 730 may be assembled, as one whole module, into the inner cavity of the casing 100 to achieve modular assembly and improve assembly efficiency. In addition, the charging receiver assembly 730 may be arranged on one side of the mounting member 500 along the second direction Y, such that the charging receiver assembly 730 may face toward the inner wall on one side of the casing 100 and match up with the charging transmitter assembly 3000 outside the casing 100. Further, the control board 720 may be arranged on the other side of the mounting member 500 along the second direction Y, such that the control board 720 may face toward the inner wall on the other side of the casing 100 and match up with a button arranged on this side.

It is worth noting that the oral cleaning apparatus provided in the embodiments of the present disclosure is generally placed in moister places such as bathrooms. When an exposed charging interface is provided on the casing 100 of the apparatus, external water vapor may contaminate the charging interface, which has a negative effect on use of the apparatus. In view of this, the oral cleaning apparatus provided in the embodiments of the present disclosure adopts a wireless charging method to avoid installing the charging interface on the opening of the casing 100 of the apparatus. In this way, charging safety is improved, and inflow of water is prevented from damaging components inside the casing.

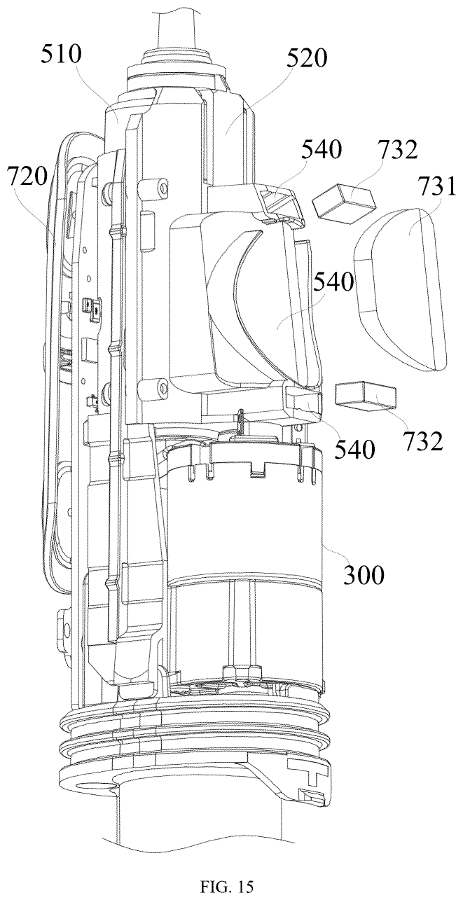

Referring to FIG. 14 and FIG. 15, the charging receiver assembly 730 may include a charging receiver 731 and a first magnet 732. The charging receiver 731 may match up with the charging transmitter assembly 3000 to transfer the electric energy. The first magnet 732 may be arranged on an outer periphery of the charging receiver 731, and a spacing may be provided between the first magnet 732 and the charging receiver 731, to prevent the first magnet 732 from adversely affecting the charging receiver 731. In addition, the first magnet 732 may magnetically attract and match up with the charging transmitter assembly 3000.

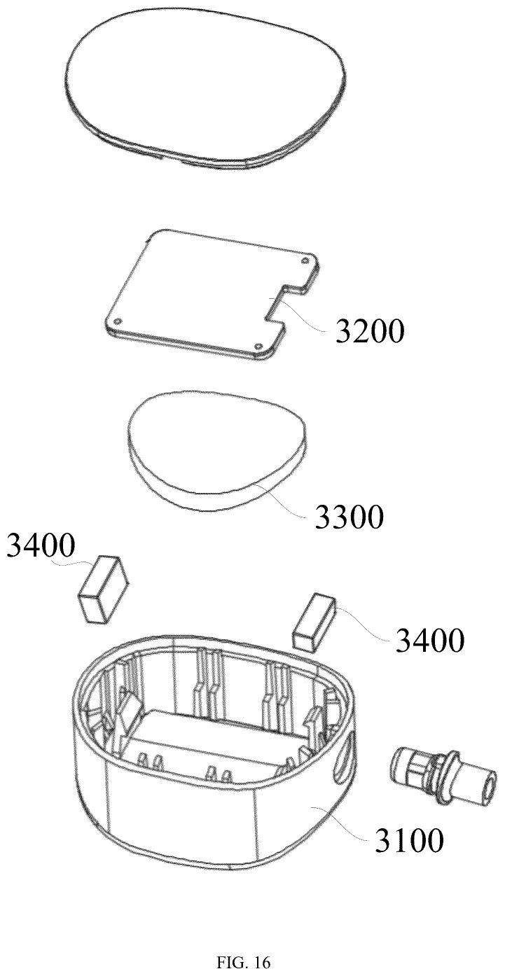

As an example, referring to FIG. 1, FIG. 14 and FIG. 16, the charging transmitter assembly 3000 may include a circuit board 3200, which may be provided with a plurality of electric devices. At least one electric device may electrically connect the charging transmitter 3300 to a power cord, allowing external electric energy to be transmitted to the charging transmitter 3300 through the power cord. The second magnet 3400 may be arranged on the outer periphery of the charging transmitter 3300, and a spacing is provided between the second magnet 3400 and the charging transmitter 3300, to avoid adversely affecting the charging transmitter 3300. When charging, the charging transmitter assembly can be connected to the oral cleaning apparatus 1000 by means of magnetic attraction force between the first magnet 732 and the second magnet 3400.

Further, there may be a plurality of first magnets 732, and at least two of the plurality of first magnets 732 may be spaced apart along the first direction X, to prevent the charging transmitter assembly 3000 from slipping off due to gravity when the apparatus is vertically placed on a desk along the first direction X. Similarly, there may be a plurality of second magnets 3400, and at least two of the plurality of second magnets 3400 may be spaced apart along the first direction X.

There may be two following ways of arranging the charging transmitter 3300 and the charging receiver 731.

In one of the two ways of arranging the charging transmitter 3300 and the charging receiver 731, the charging transmitter 3300 may be a first coil, which can generate a magnetic field according to the electric energy provided by the power cord. The charging receiver 731 may be a second coil, the second coil may be spaced apart from the first coil along an axial direction of the first coil, and the second coil can induce the magnetic field generated by the first coil and generate the electric energy. In this way, coupling between the charging transmitter 3300 and the charging receiver 731 can be achieved on the basis of electromagnetic induction principles to generate energy interaction.

Specifically, the first coil may be connected in series in a closed circuit where the power cord is positioned, and can generate a varying magnetic field when the closed circuit is turned on. To increase intensity of the varying magnetic field generated by the first coil after being energized, the first coil may be formed by winding a straight wire along a certain rectilinear direction, where number of turns of the first coil is equal to number of coils of the wire. The first coil is multiturn, and each turn may generate a magnetic field after being energized. These magnetic fields may be superposed to enhance field intensity of the first coil.

Additionally, the second coil may be connected in series in the closed circuit of the energy source 710. When magnetic flux passing through the second coil is changed, the second coil may generate induced current to supply power to the energy source 710. To induce a variation in magnetic flux to generate the induced current, specifically, an alternating current is applied to the first coil, causing the first coil to generate an alternating magnetic field, where at least a portion of alternating magnetic field passes through the second coil. As the current in the first coil changes over time, the magnetic flux passing through the second coil also changes, causing the second coil to generate the induced current.

In the other one of the two ways of arranging the charging transmitter 3300 and the charging receiver 731, the charging transmitter 3300 may be a third coil, which is a self-oscillating system. An oscillator may be connected in series between the power supply and the third coil. The oscillator can output high-frequency oscillating current to the third coil, and the third coil receives the high-frequency oscillating current and emits electromagnetic waves, such that a non-radiating magnetic field is formed around the third coil. In this way, the third coil can convert the electric energy of the power supply into the magnetic field.

In addition, the charging receiver 731 may be a fourth coil, which may have an inherent frequency. When the inherent frequency of the fourth coil is the same as the frequency of the electromagnetic waves emitted by the third coil, the fourth coil may generate a strong oscillating current. In this way, the fourth coil can convert the magnetic field into the electric energy.

Referring to FIG. 14 and FIG. 15, alternatively, the mounting member has a positioning slot for accommodating the charging receiver assembly, and the positioning slot has an opening facing away from the accommodating space. In this way, by utilizing the positioning slot, the position of the charging receiver assembly can be restricted, and rapid positioning and assembly between the charging receiver assembly and the mounting member can be achieved.

When the oral cleaner provided in the embodiments of the present disclosure is assembled, the power assembly and a charging receiver are first assembled on the bracket assembly, and then the bracket assembly, the power assembly and the charging receiver are assembled, as a whole module, in an inner cavity of a casing to achieve modular assembly and improve assembly efficiency.

Alternatively, the casing is arranged along a first direction, the bracket assembly includes a mounting member, and the motor and the charging receiver assembly are assembled, at intervals along a second direction, on the mounting member, where the second direction intersects the first direction.

Through the above solutions, the charging receiver assembly is arranged on one side of at least a portion of the power assembly along the second direction, which utilizes space of the casing in the second direction and does not hinder connection between a motor and other components.

Alternatively, the power assembly includes a motor, and the mounting member includes a first mounting part and a second mounting part, where the first mounting part and the second mounting part are in an involutory connection along the second direction and enclose to form accommodating space for accommodating the motor. At least a portion of an output shaft of the motor passes through the accommodating space, and the charging receiver assembly is arranged on an outer side of the accommodating space.

Through the above solutions, the mounting member is wrapped around the outer side of the motor, which allows the mounting member to limit and connect the motor in a circumferential direction, to improve connection stability and facilitate vibration transmission.

Alternatively, the oral cleaning apparatus also includes a control board arranged on the outer side of the accommodating space, where the control board and the charging receiver assembly are arranged on two sides of the mounting member in the second direction, respectively.

Through the above solutions, the control board and the charging receiver assembly may be arranged on two sides of the accommodating space, respectively, such that the control board may face toward an inner wall on one side of the casing and match up with a button arranged on this side, and the charging receiver assembly may face toward an inner wall on other side of the casing and match up with the charging transmitter assembly outside the casing.

Alternatively, the power assembly also includes a pump mechanism, and the pump mechanism and the motor are assembled, at intervals along the first direction, on the mounting member. The output shaft of the motor has a first flow channel that runs through the output shaft along the first direction. The bracket assembly includes a connector connected to the mounting member, where the connector has a second flow channel communicating the first flow channel and an output end of the pump mechanism.

Through the above solutions, the pump mechanism is arranged in space of the casing in the first direction, and the pump mechanism, the motor and the charging receiver assembly are all assembled on the mounting member to further achieve modular installation. In addition, the pump mechanism is communicated with the output shaft of the motor through the second flow channel of the connector, and the connector is also assembled on the mounting member, such that pipeline connection between the pump mechanism and the output shaft of the motor is more stable to avoid liquid leakage.

Alternatively, the oral cleaning apparatus also includes a water tank arranged in the inner cavity of the casing, where the water tank is positioned on one side of the bracket assembly along the first direction, and the connector has a third flow channel communicating the water tank and an input end of the pump mechanism.

Through the above solutions, in the first direction, the water tank is positioned below the bracket assembly, such that the water tank may occupy the space below the oral cleaning apparatus, making it convenient for users to clean the water tank. In addition, the casing wrapped around an outer side of the water tank has a certain length, to make it easy for the users to grip. In this way, when the oral cleaning apparatus is in use, the charging receiver assembly is not blocked by hands of the users. In this way, the oral cleaning apparatus is in service while it is charged.

Alternatively, the oral cleaning apparatus also includes an energy source arranged in the inner cavity of the casing, where the energy source is positioned on one side of the bracket assembly along the first direction, and the charging receiver assembly is electrically connected to the energy source to charge the energy source.

Through the above solutions, the energy source occupies the space below the bracket assembly, such that the casing wrapped around an outer side of the energy source has a certain length, to make it easy for the users to grip. In this way, when the oral cleaning apparatus is in use, the charging receiver assembly is not blocked by the hands of the users. In this way, the oral cleaning apparatus is in service while it is charged.

Alternatively, the charging receiver assembly includes a charging receiver, which is configured to transfer electric energy by matching up with a charging transmitter assembly.

Alternatively, the oral cleaning apparatus also includes a first magnet arranged on an outer periphery of the charging receiver, where a spacing is provided between the first magnet and the charging receiver, and the first magnet is configured to magnetically attract and match up with the charging transmitter assembly.

Through the above solutions, connection between the oral cleaning apparatus and the charging transmitter assembly is achieved by means of magnetic attraction, which has the advantage of easy installation.

Alternatively, there are a plurality of first magnets, and at least two of the plurality of first magnets are spaced apart along the first direction.

Alternatively, the charging receiver includes a second coil capable of generating the electric energy by inducing a varying magnetic field.

Alternatively, the mounting member has a positioning slot for accommodating the charging receiver assembly, and the positioning slot has an opening facing away from the accommodating space.

Through the above solutions, the positioning slot is utilized to limit a position of the charging receiver assembly, and rapid positioning and assembly between the charging receiver assembly and the mounting member can be achieved.

1. An oral cleaning apparatus, comprising a casing (100), a bracket assembly, a power assembly, and a charging receiver assembly (730), wherein the bracket assembly, the power assembly, and the charging receiver assembly (730) are all arranged in an inner cavity of the casing (100), and the power assembly and the charging receiver assembly (730) are both assembled on the bracket assembly.

2. The oral cleaning apparatus according to claim 1, wherein the casing (100) is arranged along a first direction (X);
the bracket assembly comprises a mounting member (500);
at least a portion of the power assembly and the charging receiver assembly (730) are assembled, at intervals along a second direction (Y), on the mounting member (500); and
the second direction (Y) intersects the first direction (X).

3. The oral cleaning apparatus according to claim 2, wherein the power assembly comprises a motor (200), the mounting member (500) comprises a first mounting part (510) and a second mounting part (520), the first mounting part (510) and the second mounting part (520) are in an involutory connection along the second direction (Y) and enclose to form accommodating space for accommodating the motor (200);
at least a portion of an output shaft (210) of the motor (200) passes through the accommodating space; and
the charging receiver assembly (730) is arranged on an outer side of the accommodating space.

4. The oral cleaning apparatus according to claim 3 further comprising a control board (720) arranged on the outer side of the accommodating space, wherein the control board (720) and the charging receiver assembly (730) are arranged on two sides of the mounting member (500) in the second direction (Y), respectively.

5. The oral cleaning apparatus according to claim 3, wherein the power assembly further comprises a pump mechanism (300), and the pump mechanism (300) and the motor (200) are assembled, at intervals along the first direction (X), on the mounting member (500);
the output shaft (210) of the motor (200) has a first flow channel (211) that runs through the output shaft (210) along the first direction (X); and
the bracket assembly comprises a connector (400) connected to the mounting member (500), the connector (400) having a second flow channel (410) communicating the first flow channel (211) and an output end of the pump mechanism (300).

6. The oral cleaning apparatus according to claim 5 further comprising a water tank arranged in the inner cavity of the casing (100), wherein the water tank is positioned on one side of the bracket assembly along the first direction (X), and the connector (400) has a third flow channel (420) communicating the water tank and an input end of the pump mechanism (300); and/or
the oral cleaning apparatus further comprising an energy source (710) arranged in the inner cavity of the casing (100), wherein the energy source (710) is positioned on one side of the bracket assembly along the first direction (X), and
the charging receiver assembly (730) is electrically connected to the energy source (710) to charge the energy source (710).

7. The oral cleaning apparatus according to claim 2, wherein the charging receiver assembly (730) comprises a charging receiver (731) configured to transfer electric energy by matching up with a charging transmitter assembly (3000).

8. The oral cleaning apparatus according to claim 7 further comprising a first magnet (732) arranged on an outer periphery of the charging receiver (731), wherein a spacing is provided between the first magnet (732) and the charging receiver (731), and the first magnet (732) is configured to magnetically attract and match up with the charging transmitter assembly (3000).

9. The oral cleaning apparatus according to claim 8, wherein there are a plurality of first magnets (732), and at least two of the plurality of first magnets (732) are spaced apart along the first direction (X).

10. The oral cleaning apparatus according to claim 7, wherein the charging receiver (731) comprises a second coil capable of generating electric energy by inducing a varying magnetic field.

11. The oral cleaning apparatus according to claim 2, wherein the mounting member (500) has a positioning slot (540) configured to accommodate the charging receiver assembly (730), and the positioning slot (540) has an opening facing away from the accommodating space.

12. An oral cleaning device comprising a cleaning accessory (2000) and the oral cleaning apparatus (1000) as claimed in claim 1, wherein the cleaning accessory (2000) is arranged at one end of the oral cleaning apparatus (1000).

13. An oral cleaning system comprising a charging transmitter assembly (3000) and the oral cleaning apparatus (1000) as claimed in claim 1, wherein the charging transmitter assembly (3000) matches up with the charging receiver assembly (730) of the oral cleaning apparatus (1000) to transfer electric energy.

14. The oral cleaning system according to claim 13, wherein the charging transmitter assembly (3000) comprises a base shell (3100) and a charging transmitter (3300), the charging transmitter (3300) is arranged in an inner cavity of the base shell (3100), and the charging transmitter (3300) is configured to transfer the electric energy by matching up with the charging receiver assembly (730).

15. The oral cleaning system according to claim 14, wherein when the charging receiver assembly (730) comprises a charging receiver (731) and the charging receiver (731) comprises a second coil,
the charging transmitter (3300) comprises a first coil capable of generating a varying magnetic field according to the electric energy, and the varying magnetic field enables the second coil to generate the electric energy.

16. The oral cleaning system according to claim 14, wherein the charging transmitter assembly (3000) further comprises a second magnet (3400) arranged on an outer periphery of the charging transmitter (3300), wherein a spacing is provided between the second magnet (3400) and the charging transmitter (3300), and the second magnet (3400) is configured to magnetically attract and match up with the charging receiver assembly (730).

17. The oral cleaning system according to claim 16, wherein there are a plurality of second magnets (3400), and at least two of the plurality of second magnets (3400) are spaced apart along the first direction (X).
